(19) United States
(12) Patent Application Publication
(10) Pub. No.: US 2026/0366298 A1
(43) Pub. Date: Nov. 19, 2026

(54) FIRE RESISTANT ROOF FLASHING

(71) Applicant: Aztec Manufacturing, Inc., Poway, CA (US)

(72) Inventors: Matthew DeGraan, Poway, CA (US); Farhad Noroozi Sahne, Poway, CA (US); Travis Brandt, Poway, CA (US); Foroozan Sarcon, Poway, CA (US)

(21) Appl. No.: 19/255,981

(22) Filed: Jun. 30, 2025

Related U.S. Application Data
(60) Provisional application No. 63/805,761, filed on May 14, 2025.

(51) Int. Cl. E04D 5/10; A62C 3/00; E04D 13/16

(52) U.S. Cl. CPC E04D 5/10; A62C 3/00; E04D 13/1606

(57) ABSTRACT

Disclosed herein are composite materials useful for fire resistant roof flashing. In some embodiments, the composite material comprises one or more chloroprene based synthetic rubbers, one or more bases, one or more water-generating elements, one or more crosslinking agents, one or more coloring elements, one or more rubber additives, one or more vulcanizing agents, and/or one or more UV stabilizers.

### RELATED U.S. APPLICATIONS

This application claims priority to U.S. Provisional Application No. 63/805,761, filed on May 14, 2025, which is incorporated herein by reference in its entirety. This application additionally incorporates herein by reference U.S. Provisional Application Nos. 63/805,859 and 63/805,830, each filed on May 14, 2025.

### FIELD

The present disclosure relates to the field of chemistry and roofing. More particularly, the present disclosure relates generally to fire-resistant roof flashing for metal and non-metal roofs.

### BACKGROUND

Fire poses a significant risk to homes and other buildings. Many building materials are flammable, making many buildings susceptible to wildfires and other fire-based disasters. Roofs may be especially vulnerable to fire, such as due to embers from wildfires that can land on the roof and ignite a fire.

### SUMMARY OF CERTAIN ASPECTS

In various aspects, the present technology relates to a fire-resistant material for use in buildings. Some embodiments are directed to a composite material for roof flashing and other roofing structures. In some embodiments, the composite material comprises one or more chloroprene based synthetic rubbers, one or more bases, one or more water-generating elements, one or more crosslinking agents, one or more coloring elements, one or more rubber additives, one or more vulcanizing agents, and/or one or more UV stabilizers. In some embodiments, the composite material comprises neoprene, one or more rubber additives, one or more vulcanizing agents, magnesium hydroxide, antimony trioxide, magnesium oxide, 1,2,3-trichloropropane, calcined kaolin clay, aluminum trihydroxide, carbon black, and one or more UV stabilizers.

The composite material can be adapted to provide robust flammability resistance. In some embodiments, the composite material is capable of passing a UL 94-5VA flammability test. In some embodiments, the composite material is capable of passing a UL 94-5VB flammability test.

In some embodiments, the neoprene is present at a weight percent ranging from approximately 25.0% to approximately 50.0%. In some embodiments, the magnesium hydroxide is present at a weight percent ranging from approximately 10.0% to approximately 20.0%. In some embodiments, antimony trioxide is present at a weight percent ranging from approximately 2.0% to approximately 4.0%. In some embodiments, the calcined kaolin clay is present at a weight percent ranging from approximately 5.0% to approximately 10.0%.

In some embodiments, the aluminum trihydroxide is present at a weight percent ranging from approximately 10.0% to approximately 20.0%. In some embodiments, the carbon black is present at a weight percent ranging from approximately 0.5% to approximately 2.0%. In some embodiments, the magnesium oxide is present at a weight percent ranging from approximately 1.0% to approximately 3.0%. In some embodiments, the 1,2,3-trichloropropane is present at a weight percent ranging from approximately 2.0% to approximately 8.0%.

In some embodiments, the one or more vulcanizing agents are present at a weight percent ranging from approximately 0.5% to approximately 3.0%. In some embodiments, the one or more rubber additives are present at a weight percent ranging from approximately 7.0% to approximately 15.0%. In some embodiments, the one or more UV stabilizers are present at a weight percent ranging from approximately 1.0% to 3.0%.

Not all objectives mentioned in this specification are necessarily achieved in all embodiments disclosed and/or claimed herein.

### DETAILED DESCRIPTION OF CERTAIN EMBODIMENTS

The following description provides context and examples, but should not be interpreted to limit the scope of the disclosure covered by the claims that follow in this specification or in any other application that claims priority to this specification. No single component or collection of components is essential or indispensable. For example, in some embodiments one or more variables may be omitted. Any feature, structure, component, material, step, or method that is described and/or illustrated in any embodiment in this specification can be used with or instead of any feature, structure, component, material, step, or method that is described and/or illustrated in any other embodiment in this specification.

### Certain Terminology

As used herein and unless otherwise stated or implied by context, terms have the meanings that are defined below. The descriptions of embodiments and examples that are described illustrate the disclosure and they are not intended to limit it in any way. Unless otherwise contraindicated or implied, e.g., by including mutually exclusive elements or options, in these definitions and throughout this specification, the terms “a” and “an” mean one or more and the term “or” means and/or.

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviations, per the practice in the art. Alternatively, “about” can mean a range of up to 20%, up to 10%, up to 5%, and up to 1% of a given value. Where particular values are described in the application and claims, unless otherwise stated the term “about” meaning within an acceptable error range for the particular value should be assumed.

All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control. It will be appreciated that there is an implied “about” prior to the temperatures, concentrations, times, etc. discussed in the present teachings, such that slight and insubstantial deviations are within the scope of the present teachings herein. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the general description and the following detailed description are exemplary and explanatory only and are not restrictive. The term “and/or” denotes that the provided possibilities can be used together or be used in the alternative. Thus, the term “and/or” denotes that both options exist for that set of possibilities.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “includes” should be interpreted as “includes but is not limited to;” the term “example” is used to provide exemplary instances of the item in discussion, not an exhaustive or limiting list thereof; and use of terms like “preferably,” “preferred,” “desired,” or “desirable,” and words of similar meaning should not be understood as implying that certain features are critical, essential, or even important to the structure or function of the invention, but instead as merely intended to highlight alternative or additional features that may or may not be utilized in a particular embodiment of the disclosure. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. The mere fact that certain measures are recited in mutually different dependent claims does not indicate that a combination of these measures cannot be used to a different or further advantage. Any reference signs in the claims should not be construed as limiting the scope.

### Fire Resistant Composite Materials

Aspects of the present disclosure relate to fire resistant roof flashing. In some embodiments, the composite material comprises one or more chloroprene based synthetic rubbers, one or more crosslinking agents, one or more bases, one or more water-generating elements, one or more coloring elements, one or more rubber additives, one or more vulcanizing agents, and one or more UV stabilizers. Some embodiments encompass a composite material for roof flashing comprising neoprene, one or more rubber additives, one or more vulcanizing agents, magnesium hydroxide, antimony trioxide, magnesium oxide, 1,2,3-trichloropropane, calcined kaolin clay, aluminum trihydroxide, carbon black, and one or more UV stabilizers. In some embodiments, the composite material comprises neoprene. In some embodiments, the composite material comprises one or more rubber additives. In some embodiments, the composite material comprises aluminum trihydroxide. In some embodiments, the composite material comprises magnesium hydroxide. In some embodiments, the composite material comprises carbon black. In some embodiments, the composite material comprises 1,2,3-trichloropropane. In some embodiments, the composite material comprises one or more UV stabilizers. In some embodiments, the composite material comprises one or more vulcanizing agents. In some embodiments, the composite material comprises calcined kaolin clay. In some embodiments, the composite material comprises antimony trioxide. In some embodiments, the composite material comprises magnesium oxide. In some embodiments, the composite material comprises one or more chloroprene based synthetic rubbers. In some embodiments, the composite material comprises one or more bases. In some embodiments, the composite material comprises one or more water-generating elements. In some embodiments, the composite material comprises one or more coloring elements. In some embodiments, the composite material comprises one or more crosslinking agents.

Each of the components of the composite material are combined to form a generally homogeneous brick. The homogeneous nature of the composite material allows for each component to act in synergy, as discussed in more detail below.

In some embodiments, the composite material is capable of passing a UL 94-5VA flammability test. In some embodiments, the composite material is capable of passing a UL 94-5VB flammability test.

The need to pass a UL 94-5VA and a UL 94-5VB flammability test can be significant for a fire-resistant composite material. Both tests help to ensure that any thermoplastic material placed on or near a roof can withstand the intense heat produced during a potential fire scenario.

In the composite material, each of the components work synergistically to deter fire. Aluminum trihydroxide releases water at approximately 200 °C. Magnesium hydroxide releases water at approximately 700 °C. Both compounds can work to help resist and/or quench fire. Antimony trioxide aids as a flame retardant, helping to prevent the composite material from catching fire or melting.

Carbon black can aid in the structural integrity of the composite material. For example, carbon black can increase the material's compression strength, elongation strength, and/or tensile strength.

As a polymer composite material infused with UV-resistant materials, the composite material can be resistant to oil, water, hydrocarbons such as kerosene, and UV-A and UV-B radiation.

In some embodiments, the composite material comprises one or more chloroprene based synthetic rubbers. In some embodiments, the chloroprene based synthetic rubber is neoprene.

In some embodiments, the neoprene is present at a weight percent of approximately: 10.0%, 15.0%, 20.0%, 25.0%, 30.0%, 35.0%, 40.0%, 45.0%, 50.0%, 55.0%, 60.0%, 65.0%, 70.0%, or ranges including and/or spanning the aforementioned values. For example, the neoprene may be present at a concentration ranging from approximately 25.0% to approximately 50.0%.

In some embodiments, the neoprene is neoprene WHV. In some embodiments, the neoprene is neoprene GNA. In some embodiments, the neoprene is a blend of neoprene WHV and neoprene GNA.

In some embodiments, the composite material comprises one or more bases. In some embodiments, the base is magnesium oxide. In some embodiments, the base is antimony trioxide.

In some embodiments, the magnesium oxide is present at a weight percent of approximately: 0.1%, 0.3%, 0.5%, 0.7%, 0.9%, 1.0%, 1.3%, 1.6%, 1.9%, 2.2%, 2.5%, 2.8%, 3.0%, 3.5%, 4.0%, 5.0%, or ranges including and/or spanning the aforementioned values. For example, the magnesium oxide may be present at a concentration ranging from approximately 1.0% to approximately 3.0%.

In some embodiments, antimony trioxide is present at a weight percent of approximately: 0.1%, 0.2%, 0.3%, 0.4%, 0.5%, 0.7%, 0.9%, 1.0%, 1.3%, 1.6%, 1.9%, 2.2%, 2.5%, 2.8%, 3.0%, 3.1%, 3.3%, 3.5%, 4.0%, 4.5%, 5.0%, 6.0%, 7.0%, 8.0%, or ranges including and/or spanning the aforementioned values. For example, the antimony trioxide may be present at a concentration ranging from 2.0% to approximately 4.0%.

In some embodiments, the calcined kaolin clay is present at a weight percent of approximately: 1.0%, 2.0%, 3.0%, 4.0%, 5.0%, 5.5%, 6.0%, 6.5%, 7.0%, 7.5%, 8.0%, 8.5%, 9.0%, 9.5%, 10.0%, 12.5%, 14.0%, 15.0%, 16.0%, 17.5%, 20.0%, 25.0%, or ranges including and/or spanning the aforementioned values. For example, the calcined kaolin clay may be present at a concentration ranging from approximately 5.0% to approximately 10.0%.

In some embodiments, the calcined kaolin clay is Polyfil 70.

In some embodiments, the composite material comprises one or more water-generating agents. In some embodiments, the water-generating agent is aluminum trihydroxide. In some embodiments, the water-generating agent is magnesium hydroxide.

In some embodiments, the aluminum trihydroxide is present at a weight percent of approximately: 1.0%, 5.0%, 7.5%, 10.0%, 12.5%, 13.5%, 14.0%, 14.5%, 15.0%, 15.5%, 16.0%, 16.5%, 17.5%, 20.0%, 25.0%, 30.0%, 35.0%, 40.0%, 45.0%, or ranges including and/or spanning the aforementioned values. For example, the aluminum trihydroxide may be present at a concentration ranging from 10.0% to approximately 20.0%.

In some embodiments, the composite material comprises one or more coloring elements. In some embodiments, the coloring agent is carbon black.

In some embodiments, the carbon black is present at a weight percent of approximately: 0.1%, 0.2%, 0.3%, 0.4%, 0.5%, 0.7%, 0.9%, 1.0%, 1.3%, 1.6%, 1.9%, 2.2%, 2.5%, 2.8%, 3.0%, 3.5%, 4.0%, 5.0%, or ranges including and/or spanning the aforementioned values. For example, the carbon black may be present at a concentration ranging from 0.5% to approximately 2.0%.

In some embodiments, the magnesium hydroxide is present at a weight percent of approximately: 1.0%, 5.0%, 7.5%, 10.0%, 12.5%, 13.5%, 14.0%, 14.5%, 15.0%, 15.5%, 16.0%, 16.5%, 17.5%, 20.0%, 25.0%, 30.0%, 35.0%, 40.0%, 45.0%, or ranges including and/or spanning the aforementioned values. For example, the magnesium hydroxide may be present at a concentration ranging from 10.0% to approximately 20.0%.

In some embodiments, the composite material contains one or more crosslinking agents. In some embodiments, the crosslinking agent is 1,2,3-trichloropropane.

In some embodiments, the 1,2,3-trichloropropane is present at a weight percent of approximately: 1.0%, 2.0%, 2.5%, 2.7%, 3.0%, 3.2%, 3.5%, 3.7%, 3.9%, 4.0%, 4.1%, 4.3%, 4.5%, 5.0%, 5.5%, 6.0%, 6.5%, 7.0%, 7.5%, 8.0%, 8.5%, 9.0%, 9.5%, 10.0%, 12.5%, 14.0%, 15.0%, or ranges including and/or spanning the aforementioned values. For example, the 1,2,3-trichloropropane may be present at a concentration ranging from 2.0% to approximately 8.0%.

In some embodiments, the one or more vulcanizing agents are present at a weight percent of approximately: 0.1%, 0.2%, 0.3%, 0.4%, 0.5%, 0.6%, 0.7%, 0.8%, 0.9%, 1.0%, 1.3%, 1.6%, 1.9%, 2.2%, 2.5%, 2.8%, 3.0%, 3.5%, 4.0%, 5.0%, or ranges including and/or spanning the aforementioned values. For example, the one or more vulcanizing agents may be present at a concentration ranging from 0.5% to approximately 3.0%.

In some embodiments, the one or more vulcanizing agents may be, but is not limited to, one or more of zinc oxide, 2,3′-dithiobis(benzothiazole), N-cyclohexyl-2-benzothiazole sulfenamide, sulfur MB, N,N′-di-o-tolylguanidine, tetraethylthiuram disulfide, or a combination thereof. A person skilled in the art may also incorporate other common vulcanizing agents such as, but not limited to, lead oxide, selenium, isocyanates, amine compounds, quinone compounds, metal oxides, peroxides, sulfur-containing compounds, tellurium, or a combination thereof.

In some embodiments, the one or more rubber additives are present at a weight percent of approximately: 1.0%, 2.0%, 3.0%, 4.0%, 5.0%, 5.5%, 6.0%, 6.5%, 7.0%, 7.5%, 8.0%, 8.5%, 9.0%, 9.5%, 10.0%, 12.5%, 13.5%, 14.0%, 14.5%, 15.0%, 15.5%, 16.0%, 16.5%, 17.5%, 20.0%, 25.0%, 30.0%, or ranges including and/or spanning the aforementioned values. For example, the one or more rubber additives may be present at a concentration ranging from approximately 7.0% to approximately 15.0%.

In some embodiments, the one or more rubber additives may be rubber protectants, antiozonants, rubber deodorizers, rubber plasticizers, additives intended to improve processability, additives intended to prevent oxidation, additives intended to prevent corrosion, additives to improve heat resistance, additives to alter or enhance color, additives intended to improve uniformity and dispersion, additives to protect against weathering, additives to improve tensile strength, additives to improve elastic strength, additives to improve compressive strength, additives to improve hardness, additives to protect against radiation, or a combination thereof. In some embodiments, the one or more rubber additives may be, but are not limited to, Sun Check Wax, Wingstay 100, vanilla mask, Trilene 065, Vestenamer, stearic acid, Songlight 6220, WB 42, 2,3′-dithiobis(benzothiazole), or a combination thereof. Some embodiments incorporate additional rubber additives such as, but not limited to, chalks, clays, colloidal silicic acid, talc, bentonite, calcium silicate, calcium fluoride, bisphenol, or a combination thereof.

In some embodiments, the one or more UV stabilizers are present at a weight percent of approximately: 0.1%, 0.2%, 0.3%, 0.4%, 0.5%, 0.7%, 0.9%, 1.0%, 1.3%, 1.6%, 1.9%, 2.2%, 2.5%, 2.8%, 3.0%, 3.5%, 4.0%, 5.0%, or ranges including and/or spanning the aforementioned values. For example, the one or more UV stabilizers may be present at a concentration ranging from 1.0% to 3.0%.

The one or more UV stabilizers may be, but are not limited to, Songlight 6220, Tinuvin 622, Tinuvin 770, Chimassorb 944, Tinuvin 1130, Songsorb 2340, Cyasorb UV 3808pp5, Univul 3027, Univul 5062H, Lowlite 62, Lowlite 77, carbon black, or a combination thereof. A person skilled in the art may also incorporate additional UV stabilizers such as, but not limited to, 2-hydroxy-benzophenone and its derivatives, 2-hydroxy-benzotriazole and its derivatives, hydroxyphenyltriazine and its derivatives, titanium oxide, or a combination thereof.

The compositions include those suitable for the foregoing administration routes. The formulations may conveniently be presented in unit dosage form and may be prepared by any of the methods known in the art.

In several embodiments, the compositions contain less than about 3% by weight of impurities. The compositions can be configured for use as a roof flashing material. The compositions can be configured to be applied, for example, with a brush or caulk gun. In some variants, the compositions comprise a paste, gel, or other semisolid. In several embodiments, the compositions have a viscosity of approximately 5,000,000 to approximately 100,000,000 centipoise (cps), approximately 5,000,000 to approximately 10,000,000 cps, approximately 10,000,000 to approximately 50,000,000 cps, or approximately 50,000,000 to approximately 100,000,000 cps.

### EXAMPLES

The following examples are given for the purpose of illustrating various embodiments of the disclosure and are not meant to limit the present disclosure in any fashion. One skilled in the art will appreciate readily that the present disclosure is well adapted to carry out the objects and obtain the ends and advantages mentioned, as well as those objects, ends and advantages inherent herein. Changes therein and other uses which are encompassed within the spirit of the disclosure as defined by the scope of the claims will occur to those skilled in the art.

### Example 1

In this example, a sample of the composite material was analysed in a UL 94-5VA test. The composite material in the test was comprised of 29.2398% by weight neoprene WHV, 9.7466% by weight neoprene GNA, 0.7797% by weight Sun Check Wax, 1.1696% by weight Songlight 6220, 0.7797% by weight Wingstay 100, 0.0975% by weight vanilla mask, 3.8986% by weight Trilene 065, 7.7973% by weight Polyfil 70, 1.1696% by weight Vestenamer, 1.9493% by weight magnesium oxide, 15.5945% by weight magnesium hydroxide, 15.5945% by weight aluminum hydroxide, 1.9493% by weight zinc oxide, 3.8986% by weight 1,2,3-trichloropropane, 3.1189% by weight antimony trioxide, 0.3899% by weight stearic acid, 0.7797% by weight WB 42, 0.9747% by weight carbon black, 0.2339% by weight sulfur MB, 0.3899% by weight 2,3′-dithiobis(benzothiazole), 0.1949% by weight N-cyclohexyl-2-benzothiazole sulfenamide, 0.1559% by weight N,N′-di-o-tolylguanidine, and 0.9775% by weight tetraethylthiuram disulfide.

The composite material was exposed to 48 hours at 23 °C in one test, and then 168 hours at 70 °C in a separate test. The results of both the 48-hour test and the 168-hour test are found in Table 1 and Table 2 respectively.

TABLE 1
UL-5VA Flammability for 48 hours at 23 °C

| | Thickness | Afterflame | Afterflame | Afterglow |
|---|---|---|---|---|
| Specimen | (mm) | (t1-t5, sec) | (t5, sec) | (t5, sec) |
| 1 | 3.18 | 0 | 0 | 0 |
| 2 | 3.18 | 0 | 1 | 0 |
| 3 | 3.18 | 0 | 1 | 0 |
| 4 | 3.18 | 0 | 1 | 0 |
| 5 | 3.18 | 0 | 2 | 0 |
| Total | | 0 | 5 | 0 |
| Requirements | | | | |

| | Total | | | |
|---|---|---|---|---|
| | Afterflame | Total | Burn to | Cotton |
| Specimen | (t1-t5, sec) | Afterflame | Clamp? | Ignited? |
| 1 | 0 | 0 | No | No |
| 2 | 1 | 1 | No | No |
| 3 | 1 | 1 | No | No |
| 4 | 1 | 1 | No | No |
| 5 | 2 | 2 | No | No |
| Total | 5 | 5 | | |
| Requirements | | | | |
| UL 94-5VA | <60 sec | <60 sec | No | No |

TABLE 2
UL-5VA Flammability for 168 hours at 70 °C

| | Thickness | Afterflame | Afterflame | Afterglow |
|---|---|---|---|---|
| Specimen | (mm) | (t1-t5, sec) | (t5, sec) | (t5, sec) |
| 1 | 3.18 | 0 | 1 | 0 |
| 2 | 3.18 | 0 | 0 | 0 |
| 3 | 3.18 | 0 | 2 | 0 |
| 4 | 3.18 | 0 | 1 | 0 |
| 5 | 3.18 | 0 | 1 | 1 |
| Total | | 0 | 5 | 1 |
| Requirements | | | | |

| | Total | | | |
|---|---|---|---|---|
| | Afterflame | Total | Burn to | Cotton |
| Specimen | (t1-t5, sec) | Afterflame | Clamp? | Ignited? |
| 1 | 1 | 1 | No | No |
| 2 | 0 | 0 | No | No |
| 3 | 2 | 2 | No | No |
| 4 | 1 | 1 | No | No |
| 5 | 1 | 2 | No | No |
| Total | 5 | 6 | | |
| Requirements | | | | |
| UL 94-5VA | <60 sec | <60 sec | No | No |

The composite material withstood both the 48 hour test and the 168 hour test, passing the UL 94-5VA flammability test.

### Example 2

In this example, a sample of the composite material was analysed in a UL 94-5VB test. The composite material in the test was comprised of 29.2398% by weight neoprene WHV, 9.7466% by weight neoprene GNA, 0.7797% by weight Sun Check Wax, 1.1696% by weight Songlight 6220, 0.7797% by weight Wingstay 100, 0.0975% by weight vanilla mask, 3.8986% by weight Trilene 065, 7.7973% by weight Polyfil 70, 1.1696% by weight Vestenamer, 1.9493% by weight magnesium oxide, 15.5945% by weight magnesium hydroxide, 15.5945% by weight aluminum hydroxide, 1.9493% by weight zinc oxide, 3.8986% by weight 1,2,3-trichloropropane, 3.1189% by weight antimony trioxide, 0.3899% by weight stearic acid, 0.7797% by weight WB 42, 0.9747% by weight carbon black, 0.2339% by weight sulfur MB, 0.3899% by weight 2,3′-dithiobis(benzothiazole), 0.1949% by weight N-cyclohexyl-2-benzothiazole sulfenamide, 0.1559% by weight N,N′-di-o-tolylguanidine, and 0.9775% by weight tetraethylthiuram disulfide.

The composite material was exposed to 48 hours at 23 °C in one test, and then 168 hours at 70 °C in a separate test. The results of both the 48 hour test and the 168 hour test are found in Table 3 and Table 4 respectively.

TABLE 3
UL-5VB Flammability for 48 hours at 23 °C

| | Thickness | Afterflame | Afterflame | Afterglow |
|---|---|---|---|---|
| Specimen | (mm) | (t1-t5, sec) | (t5, sec) | (t5, sec) |
| 1 | 3.19 | 0 | 0 | 0 |
| 2 | 3.19 | 0 | 0 | 0 |
| 3 | 3.19 | 0 | 1 | 0 |
| Total | | 0 | 1 | 0 |
| Requirements | | | | |

| | Total | | | |
|---|---|---|---|---|
| | Afterflame | Total | Burn to | Cotton |
| Specimen | (t1-t5, sec) | Afterflame | Clamp? | Ignited? |
| 1 | 0 | 0 | No | No |
| 2 | 0 | 0 | No | No |
| 3 | 1 | 1 | No | No |
| Total | 1 | 1 | | |
| Requirements | | | | |
| UL 94-5VB | <60 sec | <60 sec | Yes | No |

TABLE 4
UL-5VB Flammability for 168 hours at 70 °C

| | Thickness | Afterflame | Afterflame | Afterglow |
|---|---|---|---|---|
| Specimen | (mm) | (t1-t5, sec) | (t5, sec) | (t5, sec) |
| 1 | 3.19 | 0 | 1 | 0 |
| 2 | 3.19 | 0 | 0 | 0 |
| 3 | 3.19 | 0 | 0 | 0 |
| Total | | 0 | 1 | 0 |
| Requirements | | | | |

| | Total | | | |
|---|---|---|---|---|
| | Afterflame | Total | Burn to | Cotton |
| Specimen | (t1-t5, sec) | Afterflame | Clamp? | Ignited? |
| 1 | 0 | 0 | No | No |
| 2 | 0 | 0 | No | No |
| 3 | 1 | 1 | No | No |
| Total | 1 | 1 | | |
| Requirements | | | | |
| UL 94-5VB | <60 sec | <60 sec | Yes | No |

The composite material withstood both the 48 hour test and the 168 hour test, passing the UL 94-5VB flammability test.

### SUMMARY

While some embodiments have been illustrated and described, a person with ordinary skill in the art, after reading the foregoing specification, can effect changes, substitutions of equivalents and other types of alterations to the compounds of the present technology as set forth herein. Each aspect and embodiment described above can also have included or incorporated therewith such variations or aspects as disclosed in regard to any or all of the other aspects and embodiments. Additionally, any aspect and embodiment described herein can be combined with any aspect and embodiment described in U.S. Provisional Application Nos. 63/805,859 and/or 63/805,830, each filed on May 14, 2025, which (as mentioned above) are incorporated herein by reference in their entirety.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, reagents, compounds, compositions, labeled compounds or biological systems, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

Other embodiments are set forth in the following claims, along with the full scope of equivalents to which such claims are entitled.

Although the invention has been described with reference to embodiments and examples, it should be understood that numerous and various modifications can be made without departing from the spirit of the invention. Accordingly, the invention is limited only by the following claims.

What is claimed is:

1. A composite material for roof flashing comprising:
one or more chloroprene based synthetic rubbers;
one or more bases;
1,2,3-trichloropropane;
one or more water-generating elements;
one or more coloring elements;
one or more rubber additives;
one or more vulcanizing agents; and
one or more UV stabilizers.

2. A composite material for roof flashing comprising:
neoprene;
one or more vulcanizing agents;
one or more rubber additives;
magnesium hydroxide;
antimony trioxide;
1,2,3-trichloropropane;
calcined kaolin clay;
magnesium oxide;
aluminum trihydroxide;
carbon black; and
one or more UV stabilizers.

3. The composite material of claim 2, wherein the neoprene is present at a weight percent ranging from approximately 25.0% to approximately 50.0%.

4. The composite material of claim 2, wherein the magnesium hydroxide is present at a weight percent ranging from approximately 10.0% to approximately 20.0%.

5. The composite material of claim 2, wherein antimony trioxide is present at a weight percent ranging from approximately 2.0% to approximately 4.0%.

6. The composite material of claim 2, wherein the calcined kaolin clay is present at a weight percent ranging from approximately 5.0% to approximately 10.0%.

7. The composite material of claim 2, wherein the aluminum trihydroxide is present at a weight percent ranging from approximately 10.0% to approximately 20.0%.

8. The composite material of claim 2, wherein the carbon black is present at a weight percent ranging from approximately 0.5% to approximately 2.0%.

9. The composite material of claim 2, wherein the magnesium oxide is present at a weight percent ranging from approximately 1.0% to approximately 3.0%.

10. The composite material of claim 2, wherein the one or more vulcanizing agents are present at a weight percent ranging from approximately 0.5% to approximately 3.0%.

11. The composite material of claim 2, wherein the one or more rubber additives are present at a weight percent ranging from approximately 7.0% to approximately 15.0%.

12. The composite material of claim 2, wherein the 1,2,3-trichloropropane is present at a weight percent ranging from approximately 2.0% to approximately 8.0%.

13. The composite material of claim 2, wherein the one or more UV stabilizers are present at a weight percent ranging from approximately 1.0% to 3.0%.

14. The composite material of claim 2, wherein the composite material is capable of passing a UL 94-5VA flammability test.

15. The composite material of claim 2, wherein the composite material is capable of passing a UL 94-5VB flammability test.
